(19) United States
(12) Patent Application Publication
(10) Pub. No.: US 2016/0359558 A1
(43) Pub. Date: Dec. 8, 2016

(54) SIGNALING USING IDLE PERIOD FOR CODED LIGHT

(71) Applicant: PHILIPS LIGHTING HOLDING B.V., Eindhoven (NL)

(72) Inventors: CONSTANT PAUL MARIE JOZEF BAGGEN, EINDHOVEN (NL); ROBERT JAMES DAVIES, EINDHOVEN (NL); RONALD RIETMAN, EINDHOVEN (NL); PAUL HENRICUS JOHANNES MARIA VAN VOORTHUISEN, EINDHOVEN (NL)

(21) Appl. No.: 15/117,682

(22) PCT Filed: Feb. 5, 2015
(86) PCT No.: PCT/EP2015/052349

§ 371 Date: Aug. 9, 2016

(30) Foreign Application Priority Data
Feb. 14, 2014 (EP) 14155278.6

(51) Int. Cl. H04B 10/116; H04N 5/235

(52) U.S. Cl. CPC H04B 10/116; H04N 5/2353

(57) ABSTRACT

The invention relates to an information encoder, and decoder, a signal and a method of encoding and decoding of information for a coded light system. The invention aims to provide amongst others a method for transmitting and receiving a message (msg1, . . . , msg6) in a system for visible light communication and wherein the message comprises a plurality of source symbols and wherein the method for transmitting comprises: generating a modulation signal by mapping the source symbols of the message onto channel symbols for modulating the output of the light source, wherein the message is partitioned into a plurality of packets (d1, . . . , d3) of consecutive channel symbols and wherein idle periods (i1, . . . , i5) are interspaced between each pair of adjacent packets, and wherein the duration of the idle period is varied for signaling information pertaining to the message, and modulating the output of the light source based on the modulation signal so as to transmit the message at least a predetermined number of times.

### FIELD OF THE INVENTION

The invention relates to a method of transmitting a message in a system for visible light communication, a method of receiving a message in a system for visible light communication, an information encoder for encoding a message in a system for visible light communication, an information decoder for decoding a message in a system for visible light communication, a modulated coded light signal, a computer program product downloadable from a communication network and/or stored on a computer-readable and/or microprocessor-executable medium, implementing a method of transmitting a message in a system for visible light communication and a computer program product downloadable from a communication network and/or stored on a computer-readable and/or microprocessor-executable medium for implementing a method of receiving a message in a system for visible light communication.

### BACKGROUND OF THE INVENTION

The advent of integrated lighting installations, consisting of an ever growing number of individually controllable light sources, lighting devices, luminaires, lighting arrangements and the like with advanced rendering capabilities, may be regarded as transforming lighting systems for both professional and consumer markets. This brings a desire for an intuitive control capable of fully exploiting the rendering capabilities of the complete lighting infrastructure. Several approaches have been proposed to control light sources, lighting devices, luminaires, lighting arrangements and the like.

Optical free space communications, i.e. visible light (VL) communications, for the selection and advanced control of light sources has previously been proposed, and will be referred to as coded light (CL). In general, coded light has been proposed to enable advanced control of light sources. Coded light is based on embedding of data, inter alia invisible identifiers, in the light output of the light sources. Coded light may thus be defined as the embedding of data and/or identifiers in the light output of a visible light source, wherein the embedded data and/or identifier preferably do not influence the primary lighting function of the light source. Hence, any modulation of the emitted light pertaining to data and/or identifier should be substantially invisible to humans. This allows for applications such as interactive scene setting, commissioning and re-commissioning of networked lighting systems. Coded light may be used in communications applications wherein one or more light sources in a coded lighting system are configured to emit coded light and thereby communicate information to a receiver.

More recently attention has shifted from using specialist devices to detect coded light in various applications, to the use of more prevalent smartphones as e.g. disclosed in international patent application WO2013108167 A1.

### SUMMARY OF THE INVENTION

The inventors of the enclosed embodiments have noted that in order to enable the adoption of coded light in everyday life it will be necessary to define a format for transmission of coded light that enables prolific devices such as smartphones to properly receive information modulated onto light sources, but that at the same time is future proof in that it may be used with more advanced cameras and/or receivers such as region of interest cameras. Here region of interest (ROI) cameras are referred to as cameras that allow the specification of a region of interest within the full view of the camera for which image material is captured, typically this requires specification of the size and position of the ROI.

According to the inventors, existing data formats for coded light suffer from a number of problems. A first problem is particular to the detection of coded light using a camera. When imaging a light source using a camera, typically the light source serving as a coded light transmitter may cover only a fraction of the lines of the respective frames of the images captured (See for example FIG. 1). In fact, typically only the lines covering the source contain pixels that record the intensity variations of the coded light source. All the remaining lines (and pixels) do not contain coded light information related to the source of interest. If the source is small, we effectively obtain short temporally-interrupted views of the coded light source in each respective frame and therefore the existing techniques only allow for very short messages.

Moreover many current smartphones and tablets do not allow the user or user software to control the exposure time Tₑₓₚ and ISO settings of the smartphone and/or tablet. Instead existing “automatic” build-in control algorithms often lead to long exposure times that, after camera detection, lead to heavy inter-symbol interference (ISI) between the digital symbols that are sequentially transmitted by the light source.

Finally current LED driver technology only allows for cheap, energy-efficient solutions if the bandwidth (symbol rate) of the transmitted digital signal is very limited (say a symbol rate between 1 and 8 kHz). For such low frequencies, flicker and stroboscopic effects may become serious, unless special precautions are taken in the signal format for suppressing low frequencies. Having just a DC-free code typically does not suffice.

In order to address these issues the inventors have devised a method of transmitting and receiving coded light that mitigate one or more of these shortcomings. One of the insights obtained during this process was that in order to accommodate for all constraints imposed, the bit-rate of the coded light communication channel for current smartphones would have to be fairly low. Moreover most smartphones at this moment utilize a rolling shutter camera. A particular insight is that the ‘rolling shutter’ technique typically employed by the cameras of smartphones can allow the intensity variations of a light source to be sampled and recorded on a line-by-line basis. One of the issues that the inventors struggled with was the signaling of packet information in such a harsh low bit-rate regime. The present invention aims to ameliorate this situation.

In accordance with a first aspect of the invention, a method is provided of transmitting a message in a system for visible light communication, the message comprising a plurality of source symbols, the method comprising: generating a modulation signal by mapping the source symbols of the message onto channel symbols for modulating the output of the light source, wherein the message is partitioned into a plurality of packets of consecutive channel symbols and wherein idle periods are interspaced between each pair of adjacent packets, and wherein the duration of the idle period is varied for signaling information to a receiver, and modulating the output of the light source based on the modulation signal so as to transmit the message at least a predetermined number of times.

Notably the concept of message here is used in a broad sense to designate a payload-unit. It may be possible to fit a single device identifier/address within the payload-unit, which may e.g. be used for identifying a light source. In this manner the payload-unit might be repeated indefinitely. In another scenario the payload-unit could be part of a larger set of payload-units that need to be transferred from a source device to a sink device. In such a scenario, each payload-unit may be repeated a number of times, after which another payload unit may be transferred.

The invention capitalizes on the fact that the minimal intra-message idle periods (IPIP) present in the modulation signal are in part determined by the exposure time of the slowest camera that has to be able to properly receive the encoded signal. If the IPIP is chosen so as to enable robust detection in the presence of disturbances, then variations in the idle periods can be made without detrimental effect on the further encoding/decoding structure.

As a result the present invention enables signaling of information pertaining to the message as a whole, individual packets and/or selected packets to a receiver/information decoder.

Preferably the duration of the idle period is varied for signaling information pertaining to the message transmitted.

In an embodiment all channel symbols have an equal duration, as a result of this feature the predictability of the packet size increases and variations in the idle periods can be more subtle.

In an embodiment an inter-packet idle period has a duration of an integer multiple of the duration of the channel symbols. As a result the detection of the inter-packet idle period duration and selection of the sample point for channel symbol detection is simplified.

In an embodiment an inter-message idle period has a duration of an integer multiple of the duration of the channel symbols. As a result the detection of the inter-message idle period duration and selection of the sample point for channel symbol detection is simplified.

In an embodiment the inter-packet idle periods are shorter than the inter-message idle periods. This allows better distinction between the start of each repetition of a message and thus facilitates clock synchronization and the selection of the sample point for channel symbol detection. Alternatively the inter-message idle periods can be selected to be shorter than the inter-packet idle periods, however as there typically are more inter-packet idle periods than inter-message idle periods the preferred embodiment is one wherein the inter-packet idle periods are shorter than the inter-message idle periods.

In an embodiment the encoder is arranged to take into account detection of the coded light by means of a rolling shutter digital camera having an exposure time in the range from (T_{exp,min}, T_{exp,max}) and wherein the inter-packet idle period is greater than or equal to 80% of the longest exposure time T_{exp,max}, and more preferably the inter-packet idle period is greater than or equal to the longest exposure time T_{exp,max}. The underlying rationale is that the process of imaging the coded light source using a rolling shutter camera introduces Inter-Symbol-Interference (ISI). On closer inspection the transfer function of the modulated signal to the received signal, resembles convolving the modulated signal by means of a rectangular box function, corresponding to a FIR filter action of the exposure time, i.e. a moving average over Tₑₓₚ seconds. As a result by using an inter-packet idle period greater than the longest exposure time, ISI can be reduced.

In an embodiment the message is transmitted a predetermined number of times with a timing such that, when samples of the coded light signal are obtained using a digital camera over a plurality of frames, from a smaller number of lines than exposed by the camera in each frame, and the message has a duration longer than the duration of said number of lines, a different part of the message is seen by the camera in each of the plurality of said frames, and the whole message can be seen during the predetermined number of transmissions of the message. By making sure that the message duration and exposure time are such that each frame new samples from the message are obtained, a rolling shutter camera implementation can capture the entire message in spite of only seeing a small number of samples in every frame.

In an embodiment the mapped message duration is unaffected by the idle period signaling, as a result the message duration will not change when idle period variations are used for signaling.

In a preferred embodiment, the idle period signaling comprises shortening one or more inter-packet idle periods within the message and extending the inter-message idle period so as to preserve the message duration, in this manner only the data packets within the message will shift.

In another embodiment the duration of the idle period is used to signal the type of information present in the message, and more preferably the type is at least one from: header, payload, error detection, and error correction. Using the above approach it may be possible e.g. to shorten the duration of the idle period to signal when error correction information is provided in one individual packet of a message. Notably the encoder and decoder need to use the same semantics. However, these can be agreed upon beforehand and e.g. encoded in software or hardware, or might be communicated using a(n RF) side-channel or might be (partially) discovered by the receiver through a search process.

In another embodiment the duration of the idle period is used to signal a position of a particular type of information, and more preferably wherein the duration of the inter-message idle period is used to signal at least one from, the start and the end of a message.

In another embodiment at least one least significant bit of the idle period duration is used for signaling information, and more preferable at least one least significant bit of the idle period duration is used for signaling information pertaining to the message. In this manner a relatively fine grain control for signaling information to the receiver may be realized.

In another embodiment the duration of the idle period is used to signal a position of a particular type of information, for example when there are multiple idle periods present in a message, the shortening of an inter-packet idle period may signify that the subsequent packets following the respective idle periods in the message comprise error detection/correction code packets. Here the idle period thus signals the first packet of the error detection code.

Alternatively a duration of an idle period larger than the default inter-packet idle period at the start of a message may signify the start of the message, likewise the duration of an idle period larger than the default inter-packet idle period at the end of a message may signify the end of the message.

In a preferred embodiment the method makes use of Manchester channel symbols, or more preferably Ternary Manchester channel symbols as disclosed in WO2012/052935. The advantage of using Ternary Manchester codes is that it represents a DC²-free modulation code, leading to extra suppression of low frequency components, thus eliminating flicker at low symbol frequencies in the emitted light.

In accordance with a second aspect of the invention, a modulated coded light signal is provided the modulated coded light signal carrying a message comprising a plurality of source symbols, the modulation of the coded light signal resulting from modulation of the output of a light source based on a modulation signal so as to transmit the message at least a predetermined number of times, the modulation signal resulting from a mapping of the source symbols of the message onto channel symbols for modulating the output of the light source, wherein the message is partitioned into a plurality of packets of consecutive channel symbols and wherein idle periods are interspaced between each pair of adjacent packets, and wherein the duration of the idle period is varied for signaling information to a receiver. The advantages of the signal have already been described with reference to the first aspect.

Preferably the duration of the idle period in the modulated coded light signal is varied for signaling information pertaining to the message transmitted.

In accordance with a third aspect of the invention a method of receiving a message in a system for visible light communication is provided, the message comprising a plurality of source symbols, the method comprising: receiving light at a sensor, the sensor being exposed to light modulated by a light source of a visible light communication device, demodulating the data comprised in the received light, the demodulating comprising: detecting channel symbols in the received light, mapping the detected channel symbols of a received message onto source symbols for further processing, the detected channel symbols comprising a plurality of packets of consecutive channel symbols and wherein idle periods are interspaced between each pair of adjacent packets, and determining the duration of an idle period between a pair of adjacent packets. The advantage of using variations in the idle period duration for signaling information pertaining to the message is that it does not detract from the message bandwidth provided in the payload packets and allows signaling in a manner that is transparent for payload processing, but instead provides an alternative signaling channel that can be used for a variety of applications.

More preferably the above method further comprises a step of processing the received message in dependence of the determined idle period duration.

In a further embodiment of the third aspect, the sensor is a camera, and wherein the demodulating further comprises: reassembling a received message indicative of transmitted channel symbols by: collecting samples based on image lines comprising light emitted by the coded light source imaged therein, assembling the received message by collecting samples from a plurality of images of an image sequence imaging the coded light source, taking into account the message duration T_{msg}, the camera exposure time Tₑₓₚ, and the line timing of lines in the image, and continuing collection and assembly until samples have been assembled for the full message duration.

In accordance with an further embodiment of the third aspect the method may be applied in conjunction with an industrial region of interest camera, albeit that the collection and assembly of the message in such a case may be more convenient then for a rolling shutter camera as every frame will yield a number of samples and re-assembly is more straightforward. In contrast for a rolling shutter camera with a long exposure time, the re-assembly process may be more cumbersome as will be demonstrated later on.

In accordance with a fourth aspect of the invention an information encoder is provided for encoding a message in a system for visible light communication, the encoder comprising: a signal generator arranged to generate a modulation signal by mapping the source symbols of the message onto channel symbols for modulating the output of the light source, wherein the message is partitioned into a plurality of packets of consecutive channel symbols and wherein idle periods are interspaced between each pair of adjacent packets, and wherein the duration of the idle period is varied for signaling information to a receiver, and a modulator arranged to modulate the output of the light source based on the modulation signal so as to transmit the message at least a predetermined number of times. The embodiment according to the fourth aspect shares the advantages as discussed hereinabove with regard to the first aspect.

Preferably the duration of the idle period is varied for signaling information pertaining to the message transmitted.

In accordance with a fifth aspect of the invention an information decoder is provided that shares the advantages as discussed herein above with regard to the third aspect. The information decoder arranged for decoding a message in a system for visible light communication, the message comprising a plurality of source symbols, the decoder comprising: a light detector arrange to receive light, the light detector suitable for detecting light modulated by a light source of a coded light source, and a demodulator arranged to demodulate the data comprised in the received light, the demodulating comprising: detecting channel symbols in the received light, mapping the detected channel symbols of a received message onto source symbols for further processing, the detected channel symbols comprising a plurality of packets of consecutive channel symbols and wherein idle periods are interspaced between each pair of adjacent packets, and determining the duration of an idle period between a pair of adjacent packets.

More preferably the information decoder further comprises a processing unit, the processing unit arranged to process the received message in dependence of the determined idle period duration.

In accordance with a sixth aspect of the invention a computer program product downloadable from a communication network and/or stored on a computer-readable and/or microprocessor-executable medium comprising program code instructions for implementing a method according to the first aspect.

In accordance with a seventh aspect of the invention a computer program product downloadable from a communication network and/or stored on a computer-readable and/or microprocessor-executable medium comprising program code instructions for implementing a method according to the third aspect.

These and other aspects, features and advantages of the invention will be apparent from and elucidated with reference to the embodiment(s) described hereinafter.

### BRIEF DESCRIPTION OF THE DRAWINGS

Embodiments of the invention will be described, by way of example only, with reference to the drawings, in which:

FIG. 1 illustrates a lighting system according to an embodiment;

FIG. 2 illustrates a light source according to an embodiment;

FIG. 3 illustrates a coded light decoder according to an embodiment;

FIG. 4A shows a flow-chart of a method of encoding coded light;

FIG. 4B shows a flow-chart of a method of coded light detection;

FIG. 5 shows an image of a down lighter captured with a mobile phone with overlaid information;

FIG. 6 shows an image mark identifying the active pixels in an image captured by a mobile phone;

FIG. 7 shows three repetitions of a cyclically repeated message encoded using Ternary Manchester coding;

FIG. 8 shows a message consisting of 3 packets of 9 bits;

FIG. 9 shows the detected intensity for a coded light source from one hundred frames;

FIG. 10 shows detected intensity images, extended to the message duration Tmsg;

FIG. 11 shows time-aligned detected intensity images;

FIG. 12 shows combined messages based on FIG. 11,

FIG. 13 shows a reconstructed signal; and

FIG. 14 shows a number of messages using idle period signaling.

### DETAILED DESCRIPTION OF SOME EMBODIMENTS OF THE INVENTION

The below embodiments are provided by way of example so that this disclosure will be thorough and complete, and will fully convey the scope of the invention to those skilled in the art. Like numbers refer to like elements throughout.

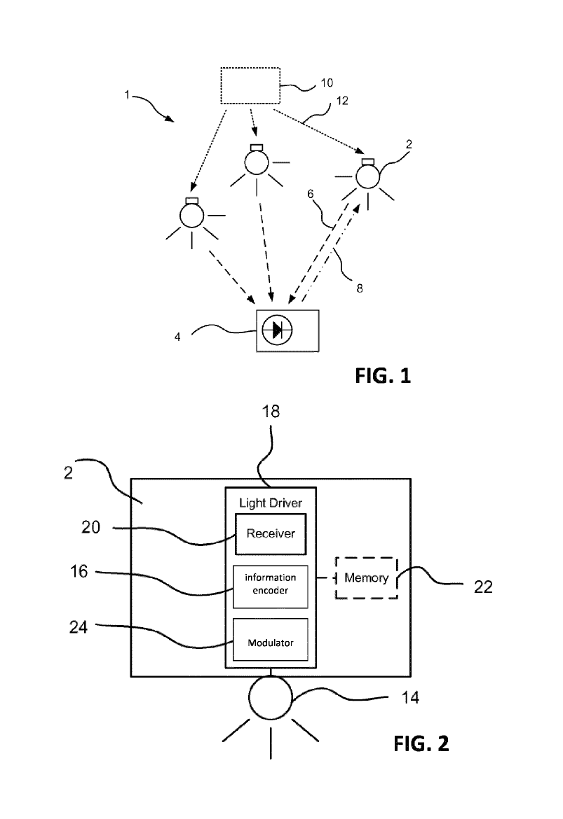

FIG. 1 illustrates a lighting system 1 that comprises at least one light source, schematically denoted by the reference numeral 2. The at least one light source 2 may be a luminaire and/or be part of a lighting control system. Each light source 2 is capable of emitting coded light, as schematically illustrated by the arrow 6. Thus the lighting system 1 may be denoted as a coded light lighting system. A luminaire may comprise at least one light source 2. The term “light source” means a device that is used for providing light in a room, for purpose of illuminating objects in the room. A room is in this context typically an apartment room or an office room, a gym hall, a room in a public place or a part of an outdoor environment, such as a part of a street.

The light sources 2 are capable of emitting coded light, the emitted light thus comprises a modulated part associated with coded light comprising information sequences. The emitted light may also comprise an un-modulated part associated with an illumination contribution. Each light source 2 may be associated with a number of lighting settings, inter alia pertaining to the illumination contribution of the light source, such as color, color temperature and intensity of the emitted light. In general terms the illumination contribution of the light source may be defined as a time-averaged output of the light emitted by the light source 2. The light source 2 will be further described with reference to FIG. 2.

As noted above the at least one light source 2 may emit one or more information sequences via the visible light 6. Notably the information sequences may change over time. Before an information sequence is emitted via the visible light 6 it is mapped to a sequence of channels symbols to form a modulated signal. This modulation signal may then act as a control signal to drive the at least one light source. The control signal may thereby determine the pulse train which switches the at least one light source 2 between emitting light (in an “ON”-state) and not emitting light (in an “OFF”-state).

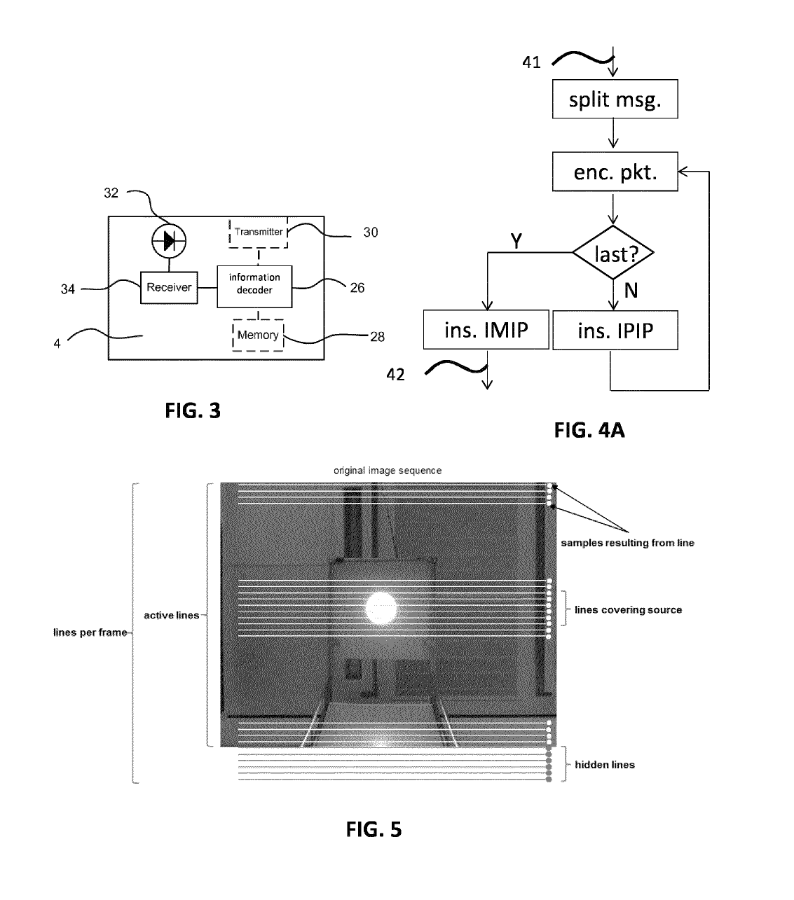

The lighting system 1 further comprises an apparatus, termed a coded light detector 4. The coded light detector 4 is arranged to decode an information sequence from coded light emitted by the at least one light source 2. The coded light detector 4 will be further described with reference to FIG. 3.

The lighting system 1 may further comprise other devices 10 arranged to control and/or provide information to the at least one light source 2.

FIG. 2 schematically illustrates, in terms of a number of functional blocks, a light source 2. The light source 2 comprises an emitter 14 for emitting coded light. The emitter 14 may comprise one or more LEDs, but it could instead or in addition comprise one or more FL or HID sources, lasers, OLEDs or other suitable light sources that can be modulated in like manner. In general, the coding schemes may utilize multiple light sources. For example, a 3-level coding scheme may have two LEDs using the mappings (OFF, OFF) for the level “−A”, (ON, OFF) for the level “0”, and (ON, ON) for the level “+A”.

The emitter is controlled by a light driver 18. The light driver 18 may comprise or be integrated with an information encoder 16, the information encoder can be realized using a processing unit such as a central processing unit (CPU).

As such the light driver 18 may comprise a receiver 20 and a modulator 24. The receiver 20 may be arranged to receive settings, control information, code parameters and the like. The receiver 20 may be a receiver configured to receive coded light. The receiver 20 may comprise an infrared interface for receiving infrared light. Alternatively the receiver 20 may be a radio receiver for receiving wirelessly transmitted information. Yet alternatively the receiver 20 may comprise a connector for receiving information transmitted by wire. The wire may be a power-line cable. The wire may be a computer cable. Information pertaining to settings, control information, code parameters and the like may be stored in the memory 22. The light driver 18 may receive information via the receiver 20 pertaining to an information sequence to be transmitted by means of coded light by the light source 2.

Alternatively if the coded light device is merely arranged to transmit a predetermined code sequence or set of code sequences, the receiver/transmitter may transmit those predetermined sequence(s) continuously. These sequences in turn may be used e.g. in the commissioning of light sources 2 within a building management system.

By utilizing the information encoder 16 the light driver 18 may change the encoding of the coded light such that the coded light emitted by the emitter 14 comprises (an encoded version of) the information sequence. In order to achieve such a transmission the light driver 18 may be arranged to perform a number of functionalities. For example when a receiver 20 is provided, the receiver 20 is arranged to receive a sequence u=[u₁, . . . , uₖ, . . . , u_{K}] of source symbols uₖ representing an information sequence of an information source. The information encoder 16 is arranged to determine, from the sequence of source symbols, a sequence z=[z₁, . . . , zₖ, . . . , z_{K}] of channel symbols zₖ forming a control or modulation signal. The modulator 24 is arranged to provide the light source 2 with the control signal and thereby drive the emitter 14. These functionalities will be described in more detail below. Alternatively, the light source 2 does not comprise a light driver. The light driver 18 may then be part of the lighting system 1.

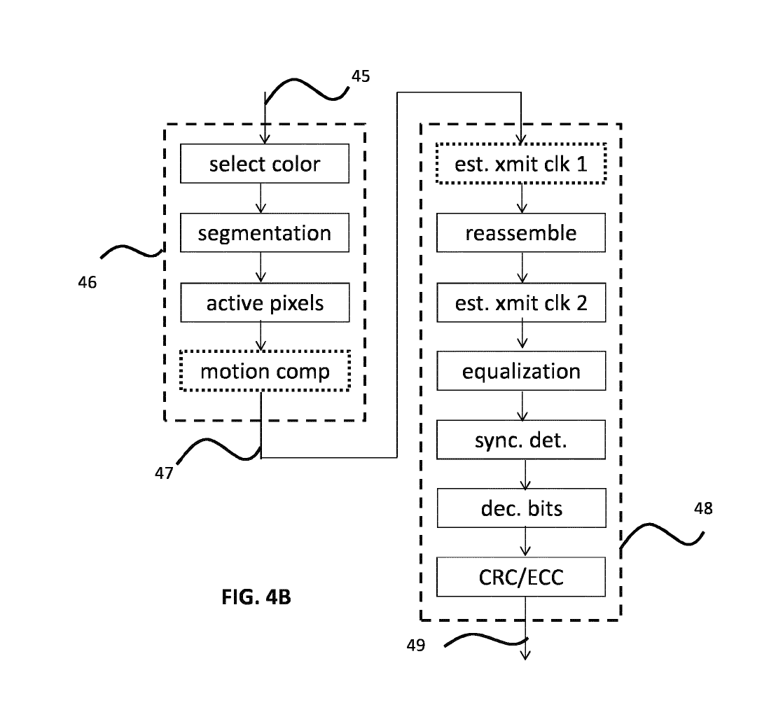

The coded light detector 4 may be arranged to detect and receive light, such as the coded light, comprising information sequences emitted by the at least one light source 2 as well as the light emitted by light sources outside the lighting system 1 (not shown). From the detected and received light the receiver 4 is arranged to determine information sequences transmitted by the at least one light source 2. A functional block diagram for a coded light detector 4 according to an embodiment of the present invention is given in FIG. 3. The coded light detector 4 comprises a receiver 34 arranged to receive the signal from a light detector or sensor 32. From the signal the decoder or demodulator, will derive a sequence \hat{z}=[\hat{z}₁, . . . , \hat{z}ₖ, . . . , \hat{z}_{K}] of channel symbols that provided there is a sufficient signal-to-noise ratio will be indicative of the sequence z=[z₁, . . . , zₖ, . . . , z_{K}]. The information decoder 26 is further arranged to determine, from the sequence z of channel symbols, a sequence û=[û₁, . . . , ûₖ, . . . , û_{K}] of decoded source symbols ûₖ forming the decoded information sequence. In order to achieve such a determination, the coded light detector 4 may be arranged to perform a number of functionalities. These functionalities will be described below with reference to the flowchart of FIG. 4b. The coded light detector 4 may further comprise a memory 28 and a transmitter 30. The memory 28 may store instructions pertaining to the functionalities to estimate an information sequence. The transmitter 30 may be utilized in order to communicate information to the at least one light source 2 in the lighting system 1.

### Coded Light Format

In order to further detail how source symbols can be mapped onto channel symbols, we will first briefly introduce the coded light format and will discuss various choices of the coded light format that was developed by the inventors. This setting provides the context for the present invention. As a result of those choices and the constraints presented by current camera phones there exists a need for an additional signaling solution outside the message payload. As such the aforementioned design choices provide context and do not preclude the application of the present invention in other systems having similar constraints.

### Bit-Rate

The bit-rate for the format was purposefully chosen to be a low bit-rate in order to make sure that the complexity of the system can be kept low, and is preferably compatible with the physical capabilities of current drivers (both Amplitude Modulation and Pulse Width Modulation).

### Channel Modulation

The next choice made was that of the channel modulation, it has been found that for the current application a DC² free code such as a Ternary Manchester (TM) code is preferable. The advantage of using a DC² free code is that it has a fairly high suppression of low frequency components; i.e. even better than a conventional Manchester code that is “merely” DC-free. Because of the low frequency of operation, DC² free codes are preferable as low frequency components in a coded light system quite easily result in flicker.

As indicated herein above, rolling shutter cameras tend to induce considerable amounts of ISI which effect gets stronger with longer message sizes. To address this problem the signal format used makes use of relatively short packets, interspersed with idle symbols, we can guarantee a message to be DC²-free, by letting each packet to be DC²-free. This is accomplished by modulating the user bits using the TM impulse response {−0.5, 1, −0.5}. Note that a packet of 9 user bits leads to a TM-encoded packet of 19 TM-symbols.

Of course, for higher bit rates, other modulation codes, such as multi-level DC-free modulation codes (e.g., Quaternary Manchester) are also envisaged provided that the spectral densities do not lead to visible flicker.

The modulation codes to be used can be defined in a manner that allows for some freedom in the actual implementation of the driver, e.g. for drivers having an Amplitude Modulation (AM) implementation or for drivers having a Pulse Width Modulation (PWM) implementation. This implies that, in contrast to traditional modulation formats, the actual shape of the waveforms to be transmitted can be adapter for particular applications.

A preferred way of defining a modulation code for coded light would be to define the rules and acceptable values of the output of a full-T moving-average filter applied to a modulator output waveform at the optimum sampling points.

### Packet Length

Experiments have shown that preferably the packet length should be chosen to be 12 bits or shorter. However better results were achieved using TM-encoded packet of 8 or 9 channel symbols at a symbol rate of 1 kHz. Notably the ISI further reduces for smaller number of bits, but the use of packets of 9 channel symbols is particularly beneficial as it allows the encoding of 8 data bits and 1 signaling bit within a single packet.

For transmitting a useful amount of information from a light source to a receiver, we construct messages which consist of a concatenation of m packets, where each packet has its own bit content. Between each two packets, there is at least an inter-packet idle period (IPIP) to prevent ISI crosstalk between different packets. Between messages there is an Inter-Message Idle Period (IMIP). In order to enable detection by low-specification rolling shutter cameras, a message consisting of m packets are cyclically repeated until even the lowest specification cameras have been given sufficient time to detect the message.

In a preferred embodiment, m=3, so effectively 3 bytes of information (24 bits) are transmitted per message. The rationale for choosing 3 packets is that the period required for robust detection of the message by a rolling shutter camera will then typically be in the range of 2 seconds. Notably when shorter exposure times are available packet sizes may be increased and/or detection speeds can be improved.

### Inter-Packet Idle Period

The purpose of the inter-packet idle period (IPIP) is to limit the ISI induced by the exposure time (Tₑₓₚ) of the camera to a single packet. Preferably the duration of the IPIP shall be equal to the maximum expected Tₑₓₚₘₐₓ. We call this a universal IPIP format, since it allows recovery of the messages for any Tₑₓₚ, i.e. when Tₑₓₚ≦IPIP=Tₑₓₚₘₐₓ.

### Inter-Message Idle Period

The inter-message idle period (IMIP) is an idle period that separates two adjacent messages. Preferably, it trails the last packet of a message. Here the length of the IMIP is measured in TM symbols. The IMIP serves two goals; firstly it is used as a parameter to make sure that the total message duration is such that rolling shutter cameras can properly decode the signal, The IMIP is therefore preferably more than 80% of the duration of Tₑₓₚ and more preferably equal to Tₑₓₚ (see also the figure description of FIGS. 5-13) and secondly, the IMIP is used to provide an asymmetry in the pattern of packets and idle periods within the cyclic repetition of messages. This property is used in the cyclic synchronization of a receiver.

### CRC

In a preferred embodiment, a message consists of several packets, where each packet contains 1 byte of information and a signaling bit. In case a CRC is used, we suggest that the last byte of each message is an 8-bit CRC and a signaling bit. Apart from using the CRC for detecting errors within a message the CRC may also be used for detecting message transitions. Consider the scenario wherein we transmit a concatenation of different messages mi, where each message mi is repeated N times, where N is a sufficient number of times such that a camera receiver can reliably reconstruct a complete message mi given the footprint of the transmitting light source.

### Total Message Duration (T_{msg})

The message duration T_{msg} is the sum of the durations of all packets and all idle periods that make up the message. Its approximate value is therefore highly dependent on the number of packets that make up the message and the durations of the idle periods. As described above, the IMIP is used to ensure a precise value that promotes ‘rolling’ in the camera.

In many embodiments, it is preferred that the message duration is preserved independently of any signaling carried by the IPIPs and it will be understood that the precise duration (or durations) that is being preserved will vary according to the configuration of the system. Nevertheless, the basic principles adopted remain the same.

After N repetitions of the same message mi, the light source can transmit a completely different message mj having the same signal parameters, by concatenating say N, repetitions of message mj right after mi. It turns out that a receiver is capable of recognizing a coherently reconstructed message by observing the CRC and thus can detect a message transition.

Alternatively in line with the present invention it may be possible to signal a new message through the use of idle period signaling.

Turning to the flow-chart presented in FIG. 4A, this flow-chart provides the flow for generating a modulation signal. Given a sequence u=[u₁, . . . , uₖ, . . . , u_{K}] of source symbols in the form of input 41, the sequence is processed. In the first step the message is split in a number of packets as described herein above. Next the encoder maps the source symbols of a packet onto channel symbols. When this is not the last packet in the message the decoder inserts an IPIP and proceeds with encoding the next packet. When the processing arrives at the last packet of the message the decoder inserts an IMIP. Notably the insertion of either IPIP or IMIP in its own right already represents a variation of the idle periods in accordance with the present invention. However more elaborate variations of the IPIP and IMIP can be implemented here.

Once the processing has inserted an IMIP idle period the entire sequence of source symbols has been converted into a modulation signal. When the same message has to be repeated a number of times, it is possible to repeat the same procedure on-the-fly, but it may be more convenient to store the encoded source symbols and reuse the modulation signal.

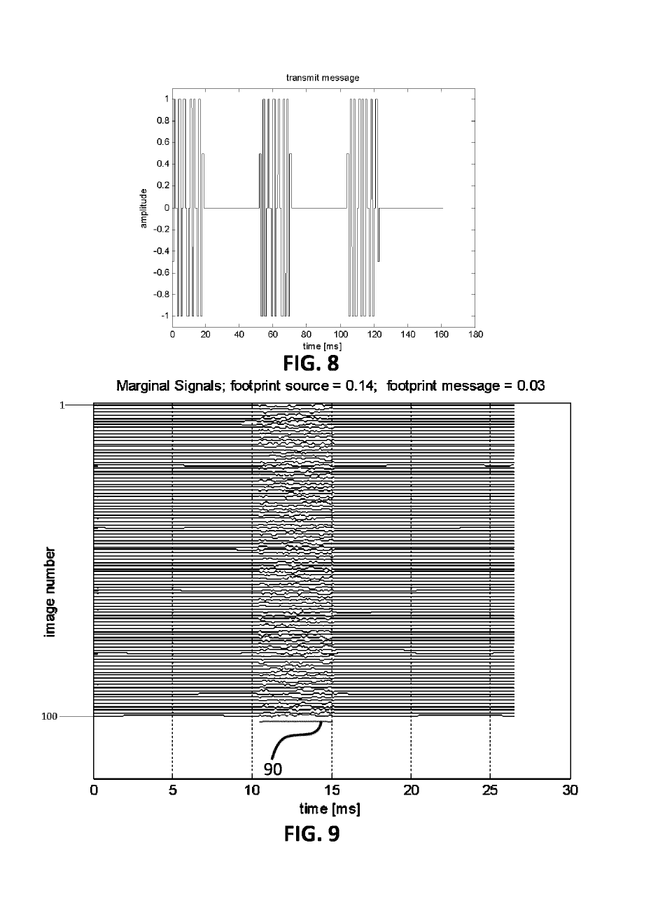

FIG. 8 shows an example of 3 packets modulated in accordance with the above described format. Note that the idle periods between the respective packets are quite sizable. FIG. 9 shows an example of a modulation signal in accordance with the above described format. Note that the modulation is superposed on top of an 80% light intensity.

As will be clear to those skilled in the art the method described above with reference to FIG. 4A merely describes a single implementation and various others implementations are envisaged; including variants wherein the entire sequence is encoded first and subsequently idle periods are inserted, or variants where channel symbols and idle periods are encoded on the fly.

Turning to FIG. 4B, FIG. 4B shows an exemplary decoder process that may be used in a coded light receiver. Notably the processing in the detector can be partitioned into 2D signal processing (dashed box 46) and 1D signal processing (dashed box 48). Next we will discuss the information decoder using sample images generated using a camera-based coded based on a movie taken in a common format. For instance, a well-known video format is the 480p format; i.e. a progressive scan format having frames taken at 29.97 frames per second (fps), where each frame consists of 480 lines and each line contains 640 pixels. The coded light receiver ail subsequently process respective images of the image sequence for obtaining the digital content of the modulated light source.

As a first step the method involves the selection of an appropriate color, typically the camera records R, G and B components. Although the Green component typically has the highest pixel density, it turns out that for the present invention, the Blue component typically is more favorable. However as will be clear to those skilled in the art, further optimization of the selection of the best possible color combination, using for example PCA could be envisaged.

FIG. 5 shows an image out of an image sequences from a ceiling mounted down-lighter. The light source is clearly visible as a bright spot. As indicated next to the image, the Tₑₓₚ for the image is based on a total number of lines per frame that extends beyond the active lines. Moreover, when we look at the number of lines that actually cover the light source, or that have contributions from the light source, it appears that only a small portion of the lines in the image will actually contain information from the light source. Part of the subsequent detection will be directed at isolating these lines.

In a next step the image is segmented in order to recognize regions in the image that can be associated with a lamp possibly transmitting coded light. Typically lights are found to correspond with high intensity regions within the image. Optionally the detector may present the user with a series of lights to select from or alternatively heuristics may be used to do so.

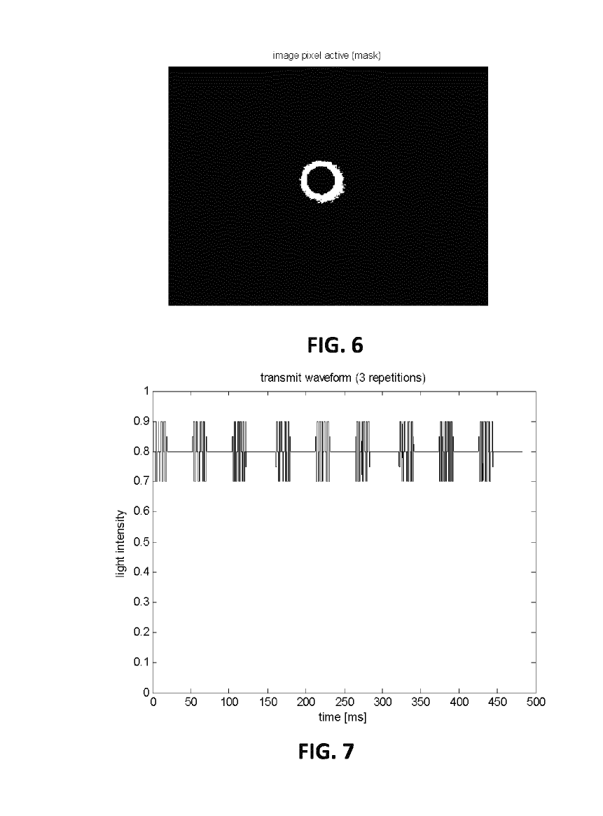

In a further step we select the active pixels, by isolating and selecting the blob of pixels corresponding to the light source we already eliminate quite a number of pixels. However even within this blob not all pixels are modulated, i.e., have sufficient intensity variations due to the modulated light source, to contribute effectively to the signal detection. Typically, pixels that are clipped are removed from further consideration. Also pixels having insufficient intensity are removed. The resulting set of “active pixels” belonging to a light source can be represented as a binary spatial 2D mask as is illustrated in FIG. 6.

The next and last step of the 2D processing is an optional motion compensation step. Notably motion compensation is called for when the detector is mounted in a hand-held device that is handled by a person. In situations like this it is important to correct for user motion so as not to disturb the message re-assembly. However, in the event both the detector and the coded light source are stationary the step could be skipped.

The subsequent steps relate to 1D processing. In the event that the footprint of the light source is much greater than the duration of the message it may be possible to use information in a captured frame to estimate the transmit clock. However, typically in particular when using a rolling shutter camera this will not be the case. As a result we need to establish known information such as the duration of the message T_{msg} and the known number of frames per second and line rate of the camera. The process of re-assembly will be explained with reference to a rolling shutter camera example.

Turning to FIG. 5, FIG. 5 shows an image captured using a rolling shutter camera. As a result of the rolling shutter each line of the image corresponds to a different moment in time. Therefore pixels on the lines that fall within the spatial 2D mask that we just established can provide an indication of the value of the coded light at the moment in time corresponding with the line timing. A single sample is determined per line taking into account the contributions of the pixels within the spatial 2D mask. These respective samples, from top to bottom correspond to the light output of the light source at increasing moments in time.

Turning to FIG. 9, FIG. 9 shows a graph wherein each horizontal line corresponds to samples from an image, notably the duration of each line corresponds roughly to ( 1/30^{th}) of a second ˜33 ms. The horizontal lines however only extend over 26.5 ms due to the hidden lines (see FIG. 5). Notably only a small section of each line (14%) comprises samples with a signal contribution. The line 90 indicates the support period; i.e. the period in the frame corresponding with the samples.

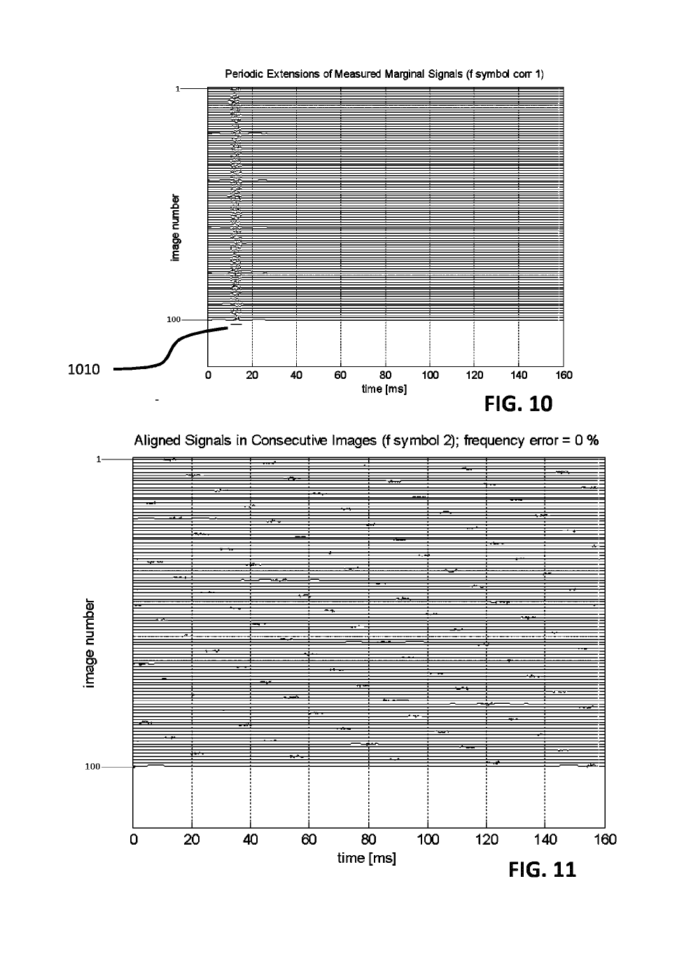

As the samples all have been captured at distinct moments in time, we need to re-align them. One way to do so is illustrated in the FIGS. 10-12. Starting at FIG. 10, FIG. 10 shows again the 100 horizontal lines from FIG. 9. This time however the lines have been extended to T_{msg}=158 ms and where Tfᵣₐₘₑ=33.36 ms. From this it will be clear that effectively each frame only captured approximately 3% of the entire message.

Next in FIG. 11 we time align the respective samples; taking into account the actual moment that the message was captured AND the fact that the message is repeated cyclically. As a result we can cyclically shift each of the samples to the proper moment in time of the actual message. From this figure it will be clear that the size of the light source in the image has a considerable impact on the number of frames needed to reconstruct the image, as the vertical height of the light source corresponds with the width of the respective support.

As the support from each frame amounted only to 0.03 of the message, we can expect that it takes at least 1/(0.03)˜33 frames for recovering a complete message. Typically, because of overlap between the messages, we need about twice that many frames for complete recovery.

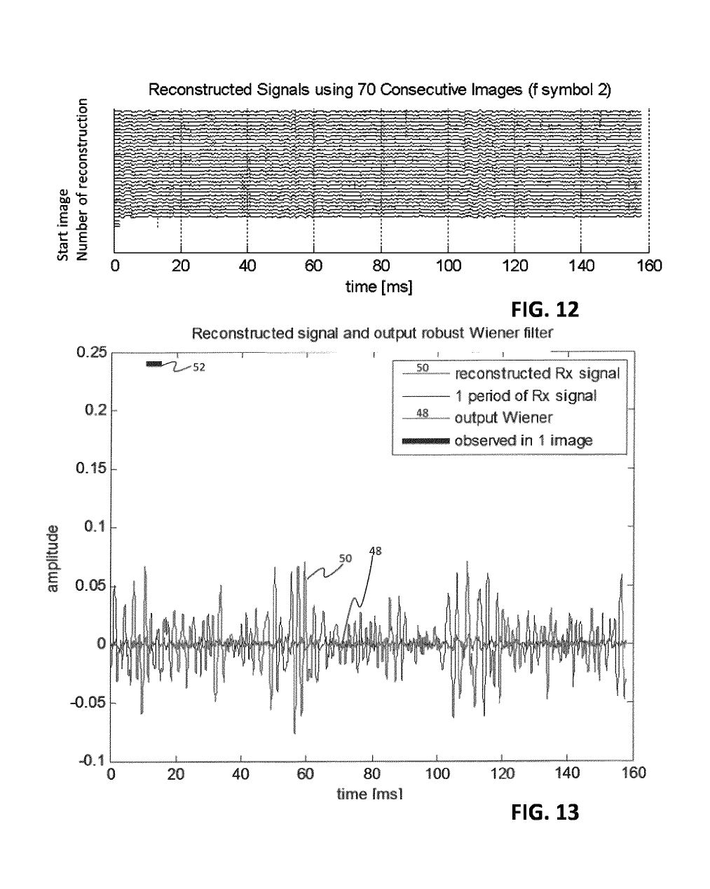

FIG. 12 shows the collapsed aligned samples of FIG. 11 from FIG. 12, we learn that the decoder, in the example, needs 70 consecutive frames for a reconstruction of a complete message (a movie of ˜2 seconds). Since each 70 consecutive frames give a reconstruction, a video of 100 frames gives 31 different reconstructions (albeit that they are dependent).

Referring back to FIG. 4B, after re-assembly of the message we can use correlation between successive reconstructed messages for estimating the transmit clock.

Once the message is re-assembled it will be equalized. The “normal” approach is to take the message and to effectively use a slicer to determine the exact timing of the signal and then equalize it. However, according to embodiments of the following, this can be achieved in a smart manner using a Wiener filter implementation that is rather efficient (preferably such that the entire decoding algorithm can be implemented on standard run-of-the-mill mobile phones).

Wiener filters as such are well known and are used for equalizing signals. In the classical Wiener filter, it is assumed that H(f), i.e. the filter to be equalized, and N(f), the noise spectral density, are known. Such conventional Wiener filters are sensitive to errors in the estimation of H(f). Some techniques have been developed in the past to deal with an unknown distortion, such as

iterative (time-consuming) approaches, where one tries to vary the target response until one gets the best result; or

mini-max approaches, where one tries to identify the worst case H(f) and optimizes the Wiener filter for this.

Use of these techniques may not provide optimal results. In order to undo the reconstructed signals from FIG. 12 from ISI in the present system, it would be desirable to provide a “powerful” equalizer filter that is insensitive to inaccuracies in the definition of H(f).

The robust Wiener filter presented below takes into consideration the uncertainty of the channel and in this manner can reduce the inter-symbol interference (ISI). In the following this filter is used following re-assembly, but may be used in other systems as well (not limited to just equalizing the effect of a rolling-shutter nor even just to coded light applications).

The robust Wiener filter can be used, e.g. for equalizing a signal that is corrupted by a filter H(f) having unknown parameters, and by additive noise. The robust Wiener is a constant filter that produces optimum results in an MSE sense, assuming that the probability distribution of the filter parameters is known.

The classical Wiener filter formulation (in the frequency domain) is:

$$G ( f ) = \frac{{H}^{*} ( f ) S ( f )}{{\vert H ( f ) \vert}^{2} S ( f ) + N ( f )}$$

where S(f) is the spectral density of the input signal X and N(f) is the spectral density of the noise term N0.

The robust Wiener filter may be described as a Wiener filter for equalizing an effect of a first filter on an input signal which is subject to the first filter and to noise and/or interference, wherein: the first filter is dependent on at least one unknown quantity; and the Wiener filter is configured based on an averaged representation of the first filter averaged over said at least one unknown quantity, in place of a representation of the first filter being assumed to be known.

Preferably said averaged representation comprises an average of the conjugate of the first filter. More preferably said averaged representation comprises an average of: the first filter multiplied by its conjugate. Yet more preferably said averaged representation comprises an average of the conjugate of the first filter and an average of: the first filter multiplied by its conjugate.

One implementation of the robust Wiener filter can be classified as:

$$G = \frac{{E}_{θ} [ {H}^{*} ] \cdot S}{{E}_{θ} [ {HH}^{*} ] \cdot S + {N}_{O}}$$

where G is the Wiener filter in the frequency domain, H is the first filter in the frequency domain, S is a spectral density of the input signal, N₀ is a spectral density of the noise and/or interference, θ is the unknown quantity, and E is the average with respect to θ.

For more details on the robust Wiener filter implementation the reader is referred to a parallel application EP14155269, filed on 14 Feb. 2014, titled “Coded Light”, by Stan Baggen, Ronald Rietman and Paul van Voorthuisen (Attorney Docket 2014PF00121), hereby incorporated by reference.

Next, in FIG. 13, we show the result of the reconstruction and robust Wiener equalization of the first reconstructed message.

The next step is to find global circular synchronization by processing using a sync template, followed by decoding the bits by making decisions on the optimum sampling points given by the global circular synchronization. Once the bit timing is available the reconstructed message can be used to:

check the CRC in order to check message integrity or

determine the IPIP and the IMIP within the messages.

The order in which these are used is dependent on whether the IPIP/IMIP is required in order to establish packets comprising CRC.

However, regardless of the order the CRC check is needed for robust detection and might be leveraged to detect message transitions.

### Idle Period Signaling

As discussed earlier on the coded light format as described herein comprises two distinct idle periods; the inter-packet idle period IPIP and the inter-message idle period IMIP. One of the purposes of both idle periods is to reduce ISI. In order to reduce ISI, preferably the duration of each of these periods is above 80% of the Tₑₓₚ of the longest exposure time. However, better performance, in particular for cameras with longer exposure times, is obtained when these periods are equal to or larger than the maximum Tₑₓₚ of all cameras detecting the coded light.

### Distinguishing Between Message Types

Consider the situation that an information encoder and an information decoder want to exchange messages, further assume that within this particular setting there are two types of data; a first message-type where data integrity is not critical and a second message-type where data integrity is critical. In order to accommodate this requirement, the present invention allows encoders and decoders to distinguish between such packets by means of idle period signaling.

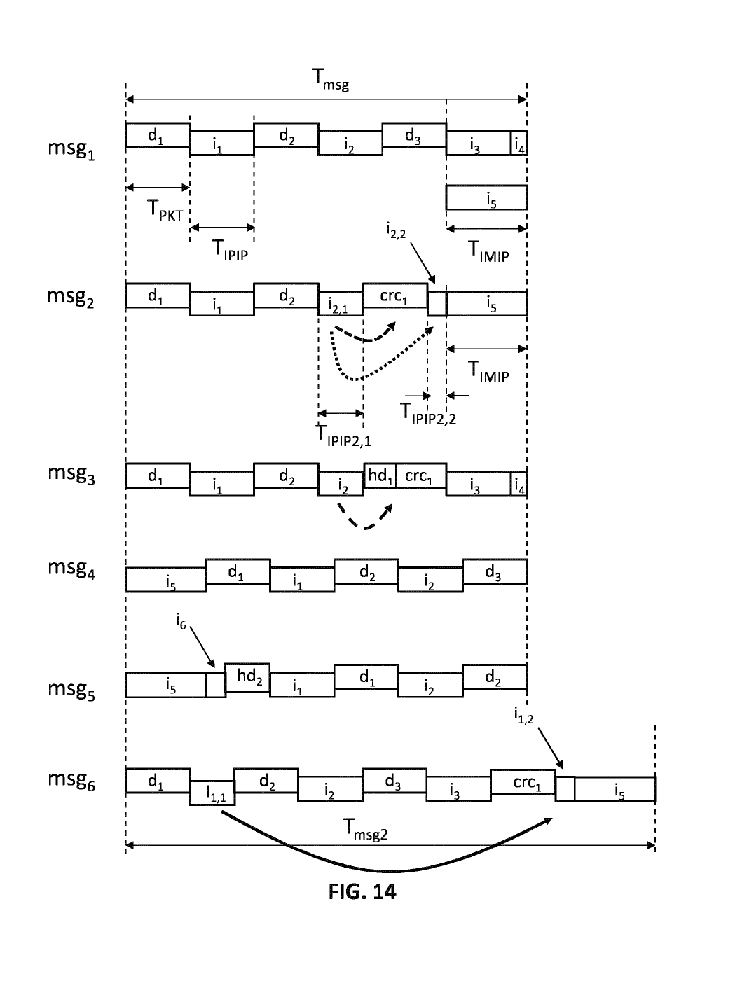

Turning now to FIG. 14, FIG. 14 shows two exemplary messages, msg₁ and msg₂ that may be used for this purpose. The first message at the top is named msg₁ and corresponds to the first message-type where data integrity is not critical. The first message type msg₁ comprises:

three data packets d₁, d₂ and d₃,

two inter packet idle periods IPIP, being i₁ and i₂, and

one trailing inter message idle period IMIP, being i₅.

Notably as in this example the IMIP>IPIP, the trailing IMIP could also be construed as corresponding to the sum of IPIP i₃ and an additional short idle period i₄.

Notably when so construed the difference between IPIP and IMIP may be construed as a basic form of idle period signaling; in that the IMIP is an IPIP with a deviant length.

Turning to the second message, the second message is named msg₂ and corresponds to the second message-type where data integrity is critical and for this reason one of the data packets d₃ is replaced by a checksum packet crc₁. In order for the information decoder to distinguish between the two, the idle period i₂ has been shortened and in order to preserve the message duration (and thereby preserve the rolling character of the message for re-assembly), the IMIP is extended with an equal amount.

As a result an information decoder in accordance with the present invention can distinguish between the first and the second message-type by inspecting the duration of the second IPIP. More in particular the information decoder may use the LSBs corresponding to the enumerated value of the duration of the second IPIP duration to discriminate between the two message types. This allows the coarse duration of the IPIP to be set in steps of 2 or 4 or so to account for the expected value of Texp (perhaps with consequent change to the message duration T_{msg} in order to promote the shortest recovery time for a given Tₑₓₚ), while retaining the ability to discriminate between message types for all values of Tₑₓₚ. In a variation of msg₂, all IPIP fields (two in the case of a message of 3 packets) are shortened by a similar amount (and the IMIP extended to preserve the message duration) in order to create a form of repetition code that improves the robustness of the IPIP signaling.

### Message-Type Look-Up Table (LUT)

Although at first glance the data packet and idle periods duration in FIG. 14 appear to be similar this is merely because it is not drawn to scale. As illustrated in FIG. 8 the IPIP and IMIP in practical implementations of the format can have a considerable duration. As a result it may be possible to vary idle periods not only by 1 but possible also by 2 or more channel symbols without detrimental effect.

Another function of the IPIP and IMIP is the recovery of the message boundary. As a result one needs to be longer than the other. Moreover the variations used for idle periods signaling should not compromise this distinctive nature. Therefore if the IMIP needs to be greater than IPIP, it is recommended to only reduce the IPIP for signaling purposes. On the other hand if the IMIP needs to be smaller than IPIP, it is recommended to only lengthen the IPIP.

Apart from using the LSB of the idle period for selecting a message-type as presented above, we can also use the deltas in the respective idle period values as indices in a look-up table, in this manner idle period signaling can help to signal the packet format of a message.

| | IPIP1 | IPIP2 | IMIP | Message contents |
|---|---|---|---|---|
| 1 | −2 | 0 | +2 | data1, data2, ecc1 (protected data) |
| | | | | odd message |
| 2 | −1 | −1 | +2 | data1, data2, ecc1 (protected data) |
| | | | | even message |
| 3 | −1 | 0 | +1 | hdr1, hdr2, ecc1 (protected header) |
| | | | | odd message |
| 4 | 0 | −2 | +2 | hdr1, hdr2, ecc1 (protected header) |
| | | | | even message |
| 5 | 0 | −1 | +1 | data1, data2, data3 (unprotected data) |
| | | | | odd message |
| 6 | 0 | 0 | 0 | data1, data2, data3 (unprotected data) |
| | | | | even message |

### Message Duration Preservation

When preserving message duration during idle period modulation the “rolling” character of the message is preserved. As indicated hereinabove a simple way to do this is to make sure that the sum of the durations of the IPIPs and IMIP remain constant (that is provided no data symbols are added, see below). This may be appropriate if the information decoder is expected to be capable of handling the message regardless of the idle period modulation, for example, when idle modulation is used to indicate whether or not the message contains a crc packet.

However it may be possible to allow subtle variations in the message duration. A receiver expecting a message of duration Tmsg1 will not see a message of duration Tmsg2 because the reconstruction described above will fail. This property of the receiver can be exploited by the transmitter to ensure that messages that cannot be processed by the information decoder or that are otherwise inappropriate are invisible to the receiver and therefore do not consume decoding resources. Such variation in message duration may be arranged independently of changes in the durations of the IPIPs and IMIP.

### Exchanging Idle Period for Channel Symbols

Although preferably the message length remains constant when signaling, it may be possible to allow subtle variations in the message duration. FIG. 14 further shows a msg3, similar to msg2, msg3 also involves shortening of i2 and the replacement of a data packet by a crc packet, however in this case instead of extending the IMIP, the equivalent of 2 channel symbols that were stripped from the idle period duration are appended as two header channel symbols, thereby providing the ability to signal 4 distinct values. Although notably in this manner the packet size will be extended, this may not be an issue, in particular when the resulting packet size remains below 12 channel symbols.

### Trailing or Leading IMIP

Although the present examples pertaining to IPIP and IMIP all have been shown with trailing IMIPs, the invention may be equally applied in systems using a leading IMIP, such as shown in msg₄ and msg₅.

### Signaling Information for Packets not Adjacent to the Idle Period

Msg₆ in turn further illustrates that the present invention is equally applicable to messages of different duration and moreover illustrates that idle period signaling may relate to packets not adjacent to the idle period.

### Signaling the Start of a Message

When transmitting clusters of messages, idle period signaling may be used to indicate the start of the cluster of messages. Likewise the idle period signaling could be used to indicate the last message of a cluster. More optionally the idle period signaling could indicate an enumeration of the messages (using e.g. the signaling as used for indexing the look-up table).

A simplified version of this mechanism is the signaling of a change of message based on e.g. the LSB corresponding to the enumerated value of the duration of the first idle period, the latter is particularly useful when the idle periods are aligned on channel symbol boundaries and the length of the idle periods is indicated as an integer indicating the number of equivalent channel symbol durations. In this manner messages from the message cluster which have an even sequence number could be coded as having a 0-bit LSB in the idle period duration and wherein odd messages from the message cluster could be coded as having a 1-bit LSB in the idle period duration.

Notably the use of the LSB bit as a flag may find application in other embodiments as well.

Further to the above it is noted that the various aspects on how particular idle period signal is to be interpreted on the receiver side (i.e. by the information decoder), can be preconfigured at manufacturing, during commissioning or during programming, or even may be notified to devices by means of an RF side-channel.

The invention can be implemented in any suitable form including hardware, software, firmware or any combination of these. The invention may optionally be implemented at least partly as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units, circuits and processors.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term comprising does not exclude the presence of other elements or steps.

Furthermore, although individually listed, a plurality of means, elements, circuits or method steps may be implemented by e.g. a single circuit, unit or processor. Additionally, although individual features may be included in different claims, these may possibly be advantageously combined, and the inclusion in different claims does not imply that a combination of features is not feasible and/or advantageous. Also the inclusion of a feature in one category of claims does not imply a limitation to this category but rather indicates that the feature is equally applicable to other claim categories as appropriate. Furthermore, the order of features in the claims do not imply any specific order in which the features must be worked and in particular the order of individual steps in a method claim does not imply that the steps must be performed in this order. Rather, the steps may be performed in any suitable order. In addition, singular references do not exclude a plurality. Thus references to “a”, “an”, “first”, “second” etc. do not preclude a plurality. Reference signs in the claims are provided merely as a clarifying example shall not be construed as limiting the scope of the claims in any way.

1. A method of transmitting a message embedded in visible illumination output by a light source in a system for visible light communication, the message comprising a plurality of source symbols, the method comprising:
generating a modulation signal by mapping the source symbols of the message onto channel symbols for modulating the illumination output by the light source, wherein the message is partitioned into a plurality of packets of consecutive channel symbols and wherein idle periods are interspaced between each pair of adjacent packets, and wherein the duration of the idle period is varied in order to provide an additional signaling channel to signal information to a receiver, and
modulating the illumination output by the light source based on the modulation signal so as to transmit the message at least a predetermined number of times.

2. The method of claim 1, wherein all channel symbols have an equal duration.

3. The method of claim 1, wherein the idle periods are characterized in that at least one of
an inter-message idle period has a duration of an integer multiple of the duration of the channel symbols,
an inter-packet idle period has a duration of an integer multiple of the duration of the channel symbols, and
the inter-packet idle periods are shorter than the inter-message idle periods.

4. The method of claim 1, wherein the method of transmitting is dimensioned for detection by means of a rolling shutter digital camera having an exposure time in the range from (T_{exp,min}, T_{exp,max}) and wherein the inter-packet idle period is greater than or equal to 80% of the longest exposure time T_{exp,max}, and more preferably the inter-packet idle period is greater than or equal to the longest exposure time T_{exp,max}.

5. The method of claim 1, wherein the message is transmitted a predetermined number of times with a timing such that, when samples of the coded light signal are obtained using a digital camera over a plurality of frames, from a smaller number of lines than exposed by the camera in each frame, and the message has a duration longer than the duration of said number of lines, a different part of the message is seen by the camera in each of the plurality of said frames, and the whole message can be seen during the predetermined number of transmissions of the message.

6. The method of claim 1, wherein the mapped message duration is unaffected by the idle period signaling.

7. The method of claim 6, wherein the idle period signaling comprises shortening one or more inter-packet idle periods within the message and extending the inter-message idle period so as to preserve the message duration.

8. The method of claim 1, wherein the duration of the idle period is used to signal the type of information present in the message, and more preferably the type is at least one from: header, payload, error detection, and error correction.

9. The method of claim 1, wherein the duration of the idle period is used to signal a position of a particular type of information, and more preferably wherein the duration of the inter-message idle period is used to signal at least one from, the start and the end of a message.

10. The method of claim 1, wherein at least one least significant bit of the idle period duration is used for signaling information, and more preferable at least one least significant bit of the idle period duration is used for signaling information pertaining to the message.

11. The method of claim 1, wherein said indication comprises an indication as to whether or not the message contains a checksum packet.

12. A method of receiving a message in a system for visible light communication, the message comprising a plurality of source symbols, the method comprising:
receiving light at a sensor, the sensor being exposed to visible illumination modulated by a light source of a visible light communication device, and
demodulating the data comprised in the received light, the demodulating comprising:
detecting channel symbols in the received light,
mapping the detected channel symbols of a received message onto source symbols for further processing, the detected channel symbols comprising a plurality of packets of consecutive channel symbols and wherein idle periods are interspaced between each pair of adjacent packets, and
determining the duration of the idle periods between the pairs of adjacent packets, in order to decode information signalled over an additional signaling channel provided by a variation in the duration of the idle periods.

13. The method of claim 12, wherein the sensor is a camera, and wherein the demodulating further comprises:
reassembling a received message indicative of transmitted channel symbols by:
collecting samples based on image lines comprising light emitted by the coded light source imaged therein,
assembling the received message by collecting samples from a plurality of images of an image sequence imaging the coded light source, taking into account the message duration T_{msg}, the camera exposure time Tₑₓₚ, and the line timing of lines in the image, and
continuing collection and assembly until samples have been assembled for the full message duration.

14. The method of claim 12, wherein the duration of the idle period is used to signal the type of information present in the message, and more preferably the type is at least one from: header, payload, error detection code, and error correction code.

15. An information encoder for encoding a message into visible illumination output by a light source in a system for visible light communication, the encoder comprising:
a signal generator arranged to generate a modulation signal by mapping the source symbols of the message onto channel symbols for modulating the illumination output by the light source, wherein the message is partitioned into a plurality of packets of consecutive channel symbols and wherein idle periods are interspaced between each pair of adjacent packets, and wherein the duration of the idle period is varied in order to provide an additional signaling channel to signal information to a receiver, and
a modulator arranged to modulate the illumination output by the light source based on the modulation signal so as to transmit the message at least a predetermined number of times.

16. A coded light source comprising:
an information encoder according to claim 15 and
a light emitter.

17. An information decoder for decoding a message in a system for visible light communication, the message comprising a plurality of source symbols, the decoder comprising:
a light detector arrange to receive light, the light detector suitable for detecting visible illumination modulated by a light source of a coded light source, and,
a demodulator arranged to demodulate the data comprised in the received light, the demodulating comprising:
detecting channel symbols in the received light,
mapping the detected channel symbols of a received message onto source symbols for further processing, the detected channel symbols comprising a plurality of packets of consecutive channel symbols and wherein idle periods are interspaced between each pair of adjacent packets, and
determining the duration of the idle periods between the pairs of adjacent packets, in order to decode information signalled over an additional signaling channel provided by a variation in the duration of the idle periods.

18. An information decoder of claim 17, wherein the light detector is a digital camera sensor, and wherein the demodulator further comprises:
a reassembler for reassembling a received message indicative of transmitted channel symbols by processing respective images captured by the digital camera sensor, the processing comprising:
collecting samples based on respective image lines comprising light emitted by the coded light source imaged therein, the sample for a respective line based on pixels that have a contribution of light from the coded light source,
assembling the received message by collecting samples from a plurality of images of an image sequence imaging the coded light source, taking into account the message duration T_{msg}, the camera exposure time Tₑₓₚ, and the line timing of lines in the image, and
continuing collection and assembly until samples have been assembled for the full message duration.

19. Computer program product downloadable from a communication network and/or stored on a computer-readable and/or microprocessor-executable medium, characterized in that it comprises program code instructions for implementing a method according to claim 1.

20. Computer program product downloadable from a communication network and/or stored on a computer-readable and/or microprocessor-executable medium, characterized in that it comprises program code instructions for implementing a method according to claim 12.
